(19) United States
(12) Patent Application Publication
(10) Pub. No.: US 2007/0220705 A1
(43) Pub. Date: Sep. 27, 2007

(54) Damper arrangement

(76) Inventors: Helmut Fitz, Lustenau (AU); Harald Sutterlutti, Fussach (AU)

Correspondence Address: WENDEROTH, LIND & PONACK, L.L.P., 2033 K STREET N. W., SUITE 800, WASHINGTON, DC, 20006-1021, US

(21) Appl. No.: 11/785,846

(22) Filed: Apr. 20, 2007

Related U.S. Application Data
(63) Continuation of application No. PCT/AT05/00306, filed on Aug. 2, 2005.

(30) Foreign Application Priority Data
Oct. 21, 2004 (DE) 20 2004 016 396.9

(51) Int. Cl. E05F 3/20; E05F 3/22

(52) U.S. Cl. 16/54

(57) ABSTRACT

The invention relates to a damping arrangement, in particular for displaceable furniture parts, comprising a damper which is provided with a tappet which can be impinged upon, and which can be supported by a support element. The support element can be positioned and/or displaced in relation to the tappet.

The present invention concerns a damper, especially for movable furniture parts, with a damper with a ram which can be subjected to pressure and which is supportable on a support element.

There are an enormous variety of dampers known in the state of the art, for example for use in movable furniture parts. These can be designed both as linear and as rotation dampers. They normally have a path-dependent damping function. This means that the degree of damping depends on how far the ram is pushed in or pulled out. In the state of the art, the ram comes into contact with a support element at the start of the damping movement, if it is not originally already permanently connected to this. The course of the damping movement is then fixed by the characteristics of the damper per se and the geometrical arrangement of damper and support element.

The object of the invention is to be able further to influence the damping function of the damper arrangement of the generic type.

This is achieved according to the invention by the fact that the support element is displaceable or slidable in its position relative to the ram.

The start, the course and the end of the damping process can additionally be influenced by the displaceable or slidable support element. When dampers with a path-dependent damping function are used, this then automatically results in an effect on the instantaneous damping value as a function of the position relative to each other of those movable furniture parts on which the damper arrangement is affixed.

It is usually desirable in that case if the ram meets the support surface on the support element assigned to it before it reaches the furniture part, fitting element, articulated lever or suchlike. This causes the damper to take effect at an earlier stage. Moreover, the ram can also be pressed into the damper more quickly than would be possible without the support element. Normally, the support area of the support element will thus be arranged between the ram and the fitting elements, articulated levers, furniture parts or suchlike arranged behind it - at least during the active damping process. It is, however, also possible by a corresponding recessed arrangement of the support element to achieve a later activation of the damper, to reduce the stroke or suchlike.

In principle, there are two possible variants in this case. The first of these makes provision that the support element is movable between a first and at least one second end position by means of a movement of the damper arrangement. In this embodiment, the support element moves automatically each time in the same way while the damper arrangement is in operation, so that the damping function of the damper used is always influenced in the same way. This variant is especially advantageous when the damping function of a fabricated damper is to be modified for a special application.

In a second group of variant embodiments of the invention, however, provision may also be made that the damper arrangement provides an adjustment device, preferably an adjustment screw, which enables the support element to be fixed in various positions relative to the ram. The support element can be fixed in various positions by the adjustment device, as the result of which a preferably manual adaptation is possible. This can be used, for example, in hinges with a damper arrangement according to the invention, to reverse a change in the damping path of the damper caused by a joint adjustment screw and/or a depth adjustment screw, in order thereby to ensure a constant damping function.

Further features of the invention are explained with the aid of the following description of some embodiments. The figures show:

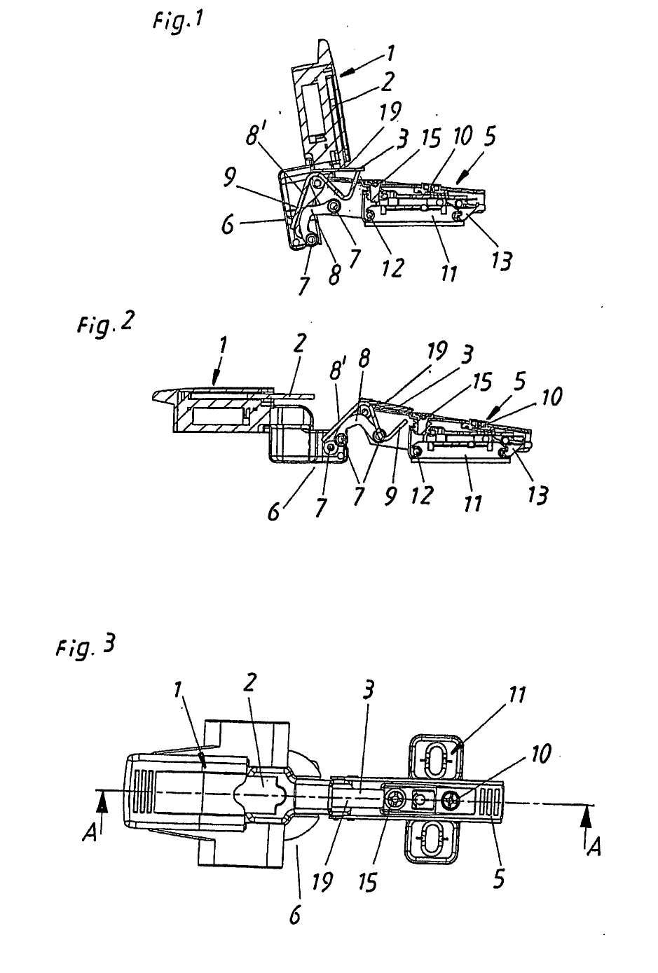

FIGS. 1 to 3: a first embodiment according to the invention,

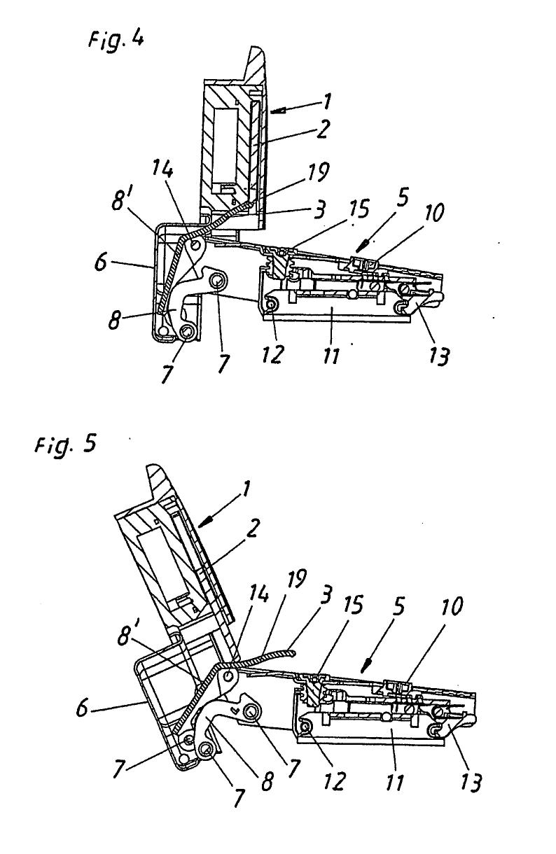

FIGS. 4 and 5: a second embodiment according to the invention,

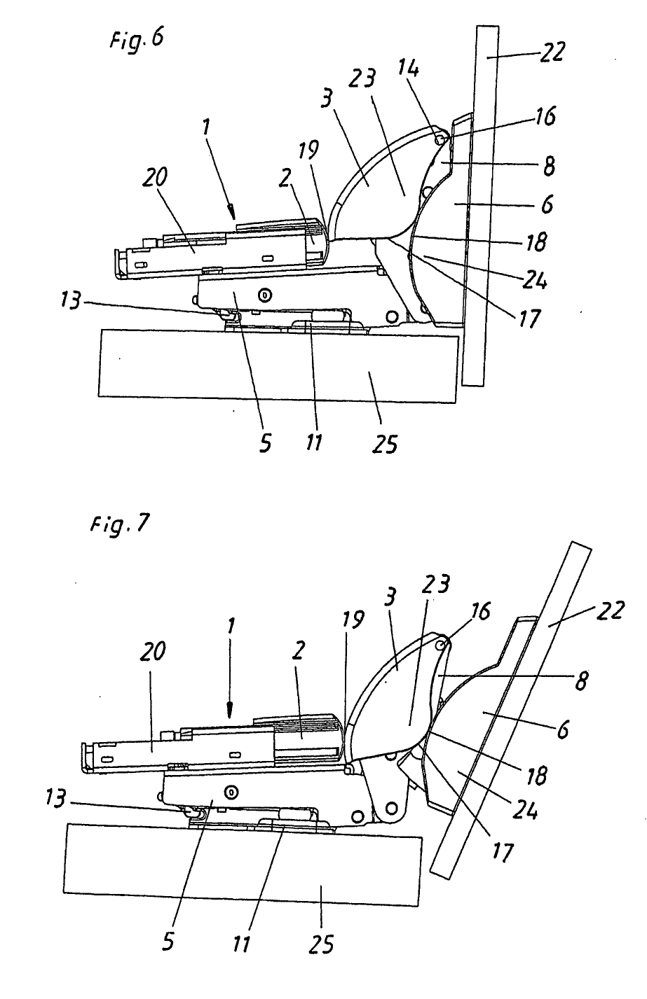

FIGS. 6 to 8: a third embodiment according to the invention and

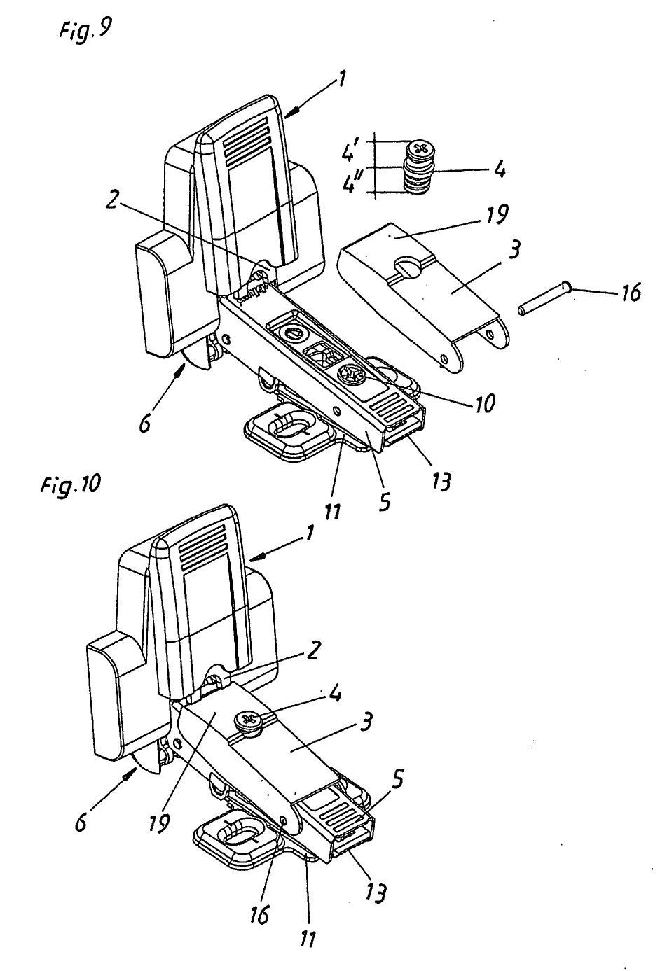

FIGS. 9 to 12: a fourth embodiment according to the invention.

The embodiment according to FIGS. 1 to 3 shows an inventive damper arrangement which is integrated into a furniture hinge with hinge arm 5 and hinge cup 6 as fitting elements. The damper 1 in this embodiment is arranged on the hinge cup 6. It has a ram 2 which travels in and out, preferably with a path-dependent damping function. The hinge arm 5 of the hinge 1 shown can, as known in the state of the art, be clipped onto a base plate 11 via a hook-on device 12 and a snap closure 13. A joint adjustment screw 15 and a depth adjustment device 10 are provided as known in the art to adjust the relative position between hinge cup and hinge arm. Hinge arm 5 and hinge cup 6 are linked by articulated levers 8 and 8′ which are arranged on articulated axles 7. According to the present invention, a movable support element 3 is now provided. In this embodiment, the support element 3 is rotatably mounted on the hinge arm 5, thus on one of the two fitting elements of the hinge. In addition, a coupling lever 9 is provided which is also rotatably mounted on the hinge arm 5. In this embodiment the coupling lever 9 is integrated into the outer articulated lever 8′. However, it may also be designed as a separate lever in addition to the articulated lever or levers 8, 8′.

FIG. 2 shows a section along the straight line AA from FIG. 3 through the inventive arrangement, where hinge cup 6 and hinge arm 5 can be seen in the folded-out position. When moving into the position shown in FIG. 1, the coupling lever 9 is pivoted relative to the arm 5. As a result, the coupling lever 9 moves the support element 3 from the position shown in FIG. 2 to that shown in FIG. 1. During the closing movement, the ram 2 comes into contact with the support element 3. By raising the support element 3, this contact occurs earlier than if the ram 2, as known in the state of the art, were to rest directly on the hinge arm 5. So the ram 2 is pushed sooner and then deeper into the cylinder of the damper 1, as the result of which, especially in dampers with path-dependent damping function, the damping value assigned to a certain angle of incidence between the fitting elements increases in each case. The coupling lever 9 in this embodiment is essentially z-shaped, but can take any other form, depending on the geometry of the damper arrangement. While in the first embodiment the coupling lever 9 is arranged such that it converts a movement of the articulated lever 8′ into a movement of the support element 3, the second embodiment according to FIGS. 4 and 5 has an inventive arrangement in which the support element 3 itself is integrated into the articulated lever 8′. The support element 3 can—in an embodiment not shown here—also alternatively be pivotably mounted on the hinge arm 5 and acted upon by the hinge cup 6, without being integrated into an articulated lever 8, 8′. The form of the support element 3 and, if applicable, of the coupling lever 9 specifies in the embodiments from when, and how far, the ram 2 is pressed into the damper 1 at the respective pivoting angles between hinge cup 6 and hinge arm 5, as the result of which, in turn, the angle-dependent damping function is influenced.

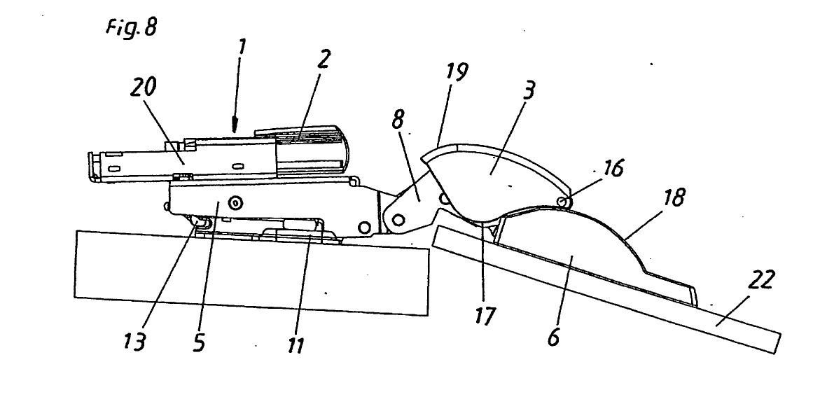

In the third embodiment according to FIGS. 6 to 8, the housing 20 of the damper 1 is anchored on the hinge arm 5. The support element 3 forms a cover with a cross-section in the form of a hollow profile over at least one articulated lever 8. It is pivotably arranged on one of the articulated levers 8 with the axle 16. In this embodiment, the second fitting element 6 is not designed as a hinge cup but, as is usual for example for glass doors, as a fitting element with planar joint faces 21. FIG. 6 shows this embodiment in the so-called closed position, in which the door 22 is closed. FIG. 7 shows an intermediate position, in which the damper is just coming into contact with the supporting area 19 of the support element 3 and is thereby activated. FIG. 8 shows the open position with open door. The pivotably arranged support element 3 in this embodiment has a control contour 17, which serves to support the support element 3. In the variant shown here, the control contour 17 rests on a guide contour 18 formed on the fitting element 6. Both contours 17 and 18 are at least partially convex in form. The forms of the convexities 23 and 24 are selected such that the ram 2 comes into contact with the supporting area 19 due to the pivoting of the support element 3 at the desired closing angle between door 22 and side wall 25. Via a corresponding design of the contours 17 and 18, there is also a guarantee that the damping characteristics of the damper 1 can be optimally exploited and the maximum possible damping stroke can be realised. It is immediately obvious to the person skilled in the art that the form of the contours 17 and 18 can be adapted to the respective damper and the respective hinge, in order to achieve the optimum of the desired damping characteristics. The support element 3 has, as in the other embodiments, the advantage that to achieve the optimum damping characteristics, it is not the form of the fitting elements or articulated lever which must be modified, but the support element 3 itself can be freely designed according to the desired specifications. When opening and closing, both the contours 17 and 18 and also the ram 2 and the support element 3 slide along each other. It would, however, also be possible to provide fixed rotational connections instead of a loose fit. Obviously it would also be possible, instead of two contours 17 and 18, also to provide only one correspondingly designed control contour 17. This could then rest on the fitting element, articulated lever or furniture part of ordinary design. Apart from this, there is also the possibility of providing a smooth, non-convex control contour 17 via a correspondingly convex or bulging design of the guide contour 18, since ultimately the decisive factor is the movement resulting from the interaction of the support element 3, which can be designed in the form of an additional structural component, and the supporting area 19 respectively.

In order to prevent the support element executing unnecessary movements or rattling, provision may be made to spring-load the support element, e.g. by a bow spring, not shown in detail here, which is connected with the support element 3 and preferably always forces this in the direction of the fitting element 6.

As is also the case in the other embodiments, it is also possible in the embodiment according to FIGS. 6 to 8 to fix the damper to the respective other fitting element. In a variation of FIGS. 6 to 8, in this variant the housing 20 of the damper 1 would then be arranged on the second fitting element 6, also executable as a hinge cup. The control contour 17 would then rest on the side of the hinge arm on a guide contour 18 which may be provided there.

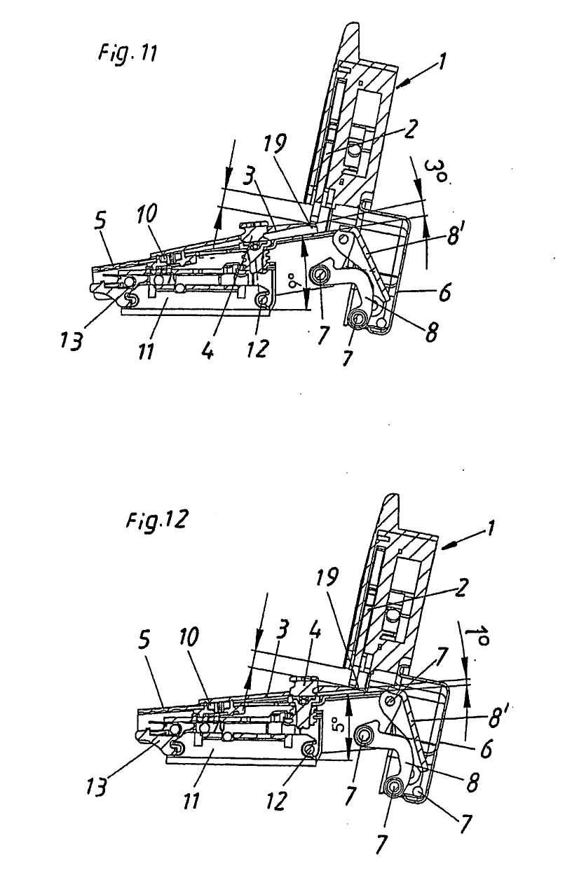

FIGS. 9 to 12 show an embodiment in which the position of the support element 3 is manually adjustable by means of an adjustment device 4. The support element 3 thereby remains fixed in the position once set during the relative movement between the fitting elements (hinge arm and hinge cup). The support element 3 is rotatably attached to an axle 16 and can be pivoted relative to the hinge arm 5. The adjustment device 4 can for example be designed as a simple adjustment screw. In the embodiment shown, however, the adjustment device 4 is realised in one structural unit with the joint adjustment device 15. To this end, the screw 4 has two areas 4′ and 4″ with different thread pitches. With the adjustment device 4 and the support element 3, it is possible to equalise a relative position between the two fitting elements 5 and 6 which has been modified by the depth adjustment device 10 and/or the joint adjustment device 15 in such a way that the same damping function of the damper exists as before the adjustment by the depth adjustment device or the joint adjustment device. Thus it is possible to adjust the damping function at least within certain limits, independently of the relative position of hinge cup 6 to hinge arm 5. One example of this is shown in FIGS. 11 and 12. By corresponding adjustments of the joint adjustment screw 4, the upper edge of the hinge arm 5 is at an angle of 9° relative to the base plate 11 in FIG. 11. An angle of 3° is set between said upper edge of the hinge arm 5 and the support element 3. If the angle between base plate 11 and upper edge of the hinge arm 5 is now reduced to 5° (see FIG. 12), then the combined adjustment device 4 automatically lowers the support element 3 to an angle of 1° relative to the upper edge of the hinge. The result of this is that in both cases the ram 2, the fitting elements being at the same angle with respect to each other, comes into contact with the support element 3 and then is immediately forced deep into the cylinder of the damper 1. The same damping function is thus exercised in both positions.

As the individual embodiments show, by using a correspondingly designed support element, an optimum damping path can be achieved for dampers known in the state of the art. This is especially advantageous in arrangements or hinge types in which the articulated levers are only moved very slightly in the last 20° of the closing movement, as the result of which a sufficient damping path cannot be achieved without the inventive support element.

Even when inventive damper arrangements are shown in the embodiments integrated in hinges, it is still possible to design damper arrangements according to the invention detached from hinges. In the case of hinges, the damper 1 and also the support element 3 can each be arranged on both fitting elements 5 and 6. Naturally, the inventive damper arrangement can also be combined with any other hinge, thus not only with hinges with hinge arm and hinge cup.

1. Damper arrangement with a first fitting element and a second fitting element and with a damper with a ram which can be subjected to pressure and which is supportable on a support element, wherein the support element is displaceable or slidable in its position relative to the ram and in its position relative to the fitting elements.

2. Damper arrangement according to claim 1, wherein the support element is movable between a first and at least one second end position by means of a movement of the damper arrangement.

3. Damper arrangement according to claim 1, wherein the ram is supportable so as to slide along the support element.

4. Damper arrangement according to claim 1, wherein the support element is mounted in such a way that it can rotate about an axle.

5. Damper arrangement according to claim 1, wherein the support element has a control contour for support of the support element, whereby the support element is displaceable or slidable or pivotable due to the support of the control contour.

6. Damper arrangement according to claim 5, wherein the control contour is made for sliding support of the support element.

7. Damper arrangement according to claim 5, wherein the support element is supported on a furniture part.

8. Damper arrangement according to claim 1, wherein the damper arrangement has a guide contour which may be disposed on a furniture part for support of the support element, whereby due to the support of the support element on the guide contour the support element is displaceable or slidable or pivotable.

9. Damper arrangement of claim 8, wherein the guide contour is made for sliding support of the support element.

10. Damper arrangement according to claim 5, wherein the control contour is supportable on the guide contour.

11. Damper arrangement according to claim 5, wherein the control contour is designed to be bulging, at least in some areas.

12. Damper arrangement according to claim 8, wherein the guide contour is designed to be bulging, at least in some areas.

13. Damper arrangement according to claim 1, wherein the damper arrangement provides an adjustment device or an adjustment screw which enables the support element to be fixed in various positions relative to the ram.

14. Damper arrangement according to claim 1, wherein it is designed such that the damper, in its movement between a first and at least one second end position, executes its maximum possible damping stroke.

15. Damper arrangement according to claim 1 designed for movable furniture parts.

16. Hinge with a damper arrangement according to claim 1.

17. Hinge with a first fitting element and a second fitting element connected therewith by means of at least one articulated axle, according to claim 16, wherein the damper and the support element are arranged or coupled respectively to different fitting elements or the damper to one of the fitting elements and the support element to an articulated lever of the hinge.

18. Hinge according to claim 16 with an articulated lever, wherein the hinge has a coupling lever which is arranged in such a way that it converts a movement of the hinge into a movement of the support element.

19. Hinge according to claim 18, wherein the coupling lever is integrated into an articulated lever of the hinge.

20. Hinge according to claim 18, wherein the coupling lever is pivotably mounted on one of the fitting elements and supportable on the other fitting element.

21. Hinge according to claim 18, wherein the coupling lever is essentially z-shaped.

22. Hinge according to claim 17, wherein the support element is pivotably mounted on one of the fitting elements.

23. Hinge according to claim 16, wherein the support element is integrated in an articulated lever of the hinge.

24. Hinge according to claim 16, wherein the support element is pivotably mounted on one of the fitting elements and supportable on the other fitting element.

25. Hinge according to claim 16, wherein it has at least one member of a group consisting of a depth adjustment device and a joint adjustment device to adjust the relative position of the two fitting elements to each other in at least one resting position and an adjustment device or a adjustment screw with which the support element can be fixed in various positions relative to the ram, wherein the adjustment device of the support element is capable of equalising any change in position caused by at least one of a group consisting of the depth adjustment device and/or the joint adjustment device.

26. Hinge according to claim 17, wherein the first fitting elements is a hinge arm.

27. Hinge according to claim 17, wherein the first fitting element is a hinge cup.
